(19) United States
(12) Patent Application Publication
(10) Pub. No.: US 2025/0384089 A1
(43) Pub. Date: Dec. 18, 2025

(54) STRING COMPARISON DEVICE AND METHOD

(71) Applicants: Vidoori, Inc., Hyattsville, MD (US); T-Rex Solutions, LLC, Bethesda, MD (US); International Business Machines Corporation, Rochester, MN (US)

(72) Inventors: Tim WITHUM, Crownsville, MD (US); Katie KLEEMAN, Washington, DC (US); Jeffrey TENNENBAUM, Dunn Loring, VA (US); Marlon ATTIKEN, Alexandria, VA (US); Phil WANG, Columbia, MD (US); Lac NGUYEN, Rockville, MD (US); Mike BAUER, Chesapeake, VA (US); Clyde RELICK, Arlington, VA (US)

(73) Assignees: Vidoori, Inc., Hyattsville, MD (US); T-Rex Solutions, LLC, Bethesda, MD (US); International Business Machines Corporation, Rochester, MN (US)

(21) Appl. No.: 19/235,124

(22) Filed: Jun. 11, 2025

Related U.S. Application Data
(60) Provisional application No. 63/659,521, filed on Jun. 13, 2024.

(51) Int. Cl. G06F 16/903; G06F 16/22; G06F 16/9038

(52) U.S. Cl. CPC G06F 16/90344; G06F 16/2237; G06F 16/9038

(57) ABSTRACT

An electronic device for record linkage including a memory storing one or more instructions, and a processor that executes the one or more instructions to generate one or more vectors of one or more strings from a reference database based on a modified Levenshtein distance, and generate a vector database for spelling similarity based on the one or more vectors. The modified Levenshtein distance is based on one or more parameters, including at least one of: a first number of insertions, a second number of deletions, a third number of replacements, or a fourth number of matches, one or more of the one or more parameters including a predefined weight, and one or more fixed strings.

### PRIORITY

This application claims priority from 35 U.S.C. § 119 to U.S. Provisional Application No. 63/659,521, filed on Jun. 13, 2024, in the United States Patent & Trademark Office, the disclosure of which is incorporated herein by reference in its entirety.

### TECHNICAL FIELD

The disclosure relates to the fields of machine learning, natural language processing, and computational linguistics, and in particular, to string corrections and/or string embedding.

### DESCRIPTIONS OF THE ART

In database technology, records of multiple databases may be linked together to leverage information that is unique to each of the individual databases. This approach may be referred to as linking or the linkage of records of the various databases. Such an approach may be applied to various statistical studies and/or the use of administrative records. For example, it may be desired to link the records of a database of Census responses (for example, names, locations, social security numbers (SSNs), ages, or races) with a database of administrative records from the IRS (for example, names, SSNs, ages, or salaries) to simultaneously use information contained in both databases. In this example, the linkage could involve the SSN that is in both databases. However, in more complicated examples, textual characteristics (for example, first names or last name) may be one or more of the fields available to both databases desired to be used as the key to record linkage. This makes linkage difficult because there may be errors in the text, which may require the use of fuzzy matching. In some cases, incoming data from one database (Database 1) contains misspellings, variations, or other discrepancies and must be matched against a second database (Database 2) to verify its authenticity. An example of an incomplete database is depicted in FIG. 5. Alternatively, the goal may be to update existing records with new information. For example, survey data may be matched against IRS records to ensure accuracy, or a user may search for a person in a database where names or other identifying characteristics might contain errors or inconsistencies.

Related art fuzzy matching techniques rely on comparators such as Jaro-Winkler or Levenshtein distance. Levenshtein distance, for instance, measures the number of insertions, deletions, or substitutions required to transform one string into another. However, accurately matching full records requires comparing each field in an input record against the corresponding fields in all potential matches from the second database. A probabilistic matching approach, such as the Fellegi-Sunter model, is then used to determine whether two records correspond.

Using related methods, in order to achieve the highest accuracy, this process must be repeated for every record in Database 1 against every record in Database 2. The number of required comparisons grows exponentially, following the formula:

Total Comparisons=(Records in DB1)×(Records in DB2)

Because string comparisons are computationally expensive, this exhaustive search can become prohibitively slow. For example, if each database contains 350 million records (as it would for databases for the entire U.S. population) and a single record comparison takes just 0.01 seconds, the total time required to compare every record pair would be:

350 M×350 M×0.01 sec×(3600 sec1 hr)×(24 hr1 day)×(365 days1 year)˜38,000 years.

An example illustration of such a search is depicted in FIG. 3. In the example above, the need to compare all possible pairs of records contributes to the overwhelming time required for a perfect match. Accordingly, a more efficient approach is needed to make large-scale fuzzy matching feasible.

Related art record linkage solutions may rely on blocking or clustering techniques that may miss matches due to relying on record elements being accurate. Moreover, these solutions may have poor performance across large databases (DBs), because the fuzzy match needs to be applied to every candidate pair of potentially matching records. Performance may be addressed by comparing records with similar characteristics (this approach is called “blocking”). For example, if a candidate record is a male, then the search of the reference database would only include those records that are males. Other approaches may include methods that only compare the first three characters of the words or only compare records where certain characteristics are the same. These approaches may suffer from inaccuracy, however, because there may be errors in the selected features (for example, an error in the first 3 characters).

In another approach, word embedding may be used to convert a string into a vector of numbers that can then be used in vector databases and other mathematical approaches which may increase the speed of the processing. Vectorization may also facilitate the simultaneous consideration of full records in the match process as opposed to blocking, which limits the scope of searched records based on characteristics that may contain errors. In other words, an error in one component of the vector can be offset by matches in other components. Unfortunately, current word embedding methods may inherently provide semantic similarity, and record linkage techniques may require vectors that convey spelling similarity. Current word embedding methods may allow the subtraction of vectors for words such as “dog” and “cat” to show that they are similar, and that “run” and “swim” are similar, for example, but such methods may also show that “dog” and “swim” are not similar. Spelling similarity may be required for record linkage in order to show that “BARBRA” and “BARBARA” are similar, but “BARBARA” and “JOHN” are different, for example. Therefore, a need for word embedding devices and methods that may facilitate better performance while providing more accurate results exists.

Related art solutions fail to utilize vectors that inherently include spelling similarity in string elements of the vectors and that allow weighted searches for vectors that are deemed similar.

Related art solutions are also unable to be visualized and analyzed with vector-based techniques and analyzed with vector-based techniques for identifying patterns and other characteristics of the data based on spelling similarity of the records.

### SUMMARY

One or more aspects of the disclosure may include solutions for these types of word embedding and may provide for the expanded use of vector math and vector databases, thereby facilitating faster performance, more accurate comparisons, and searching of records.

According to an aspect of the disclosure, there is provided an electronic device and method capable of performing accurate word comparisons without performing blocking while maintaining high performance.

According to one or more embodiments, an electronic device for record linkage, includes: a memory storing one or more instructions; and a processor configured to execute the one or more instructions to: generate one or more vectors of one or more strings from a reference database based on a modified Levenshtein distance; and generate a vector database for spelling similarity based on the one or more vectors, wherein the modified Levenshtein distance is based on one or more parameters, including at least one of: a first number of insertions, a second number of deletions, a third number of replacements, or a fourth number of matches, and wherein one or more of the one or more parameters include a predefined weight.

### BRIEF DESCRIPTION OF THE DRAWINGS

The above and other aspects, features, and advantages of certain embodiments of the present disclosure are more apparent from the following description taken in conjunction with the accompanying drawings, in which:

FIG. 1 is a block diagram of an electronic device 100 according to one or more embodiments; and

FIG. 2 illustrates visualization of a vector according to one or more embodiments.

FIG. 3 illustrates an example of string comparison according to related methods of string comparison.

FIG. 4 illustrates an example of string comparison using vectorization according to one or more embodiments.

FIG. 5 illustrates an example database to be processed according to one or more embodiments.

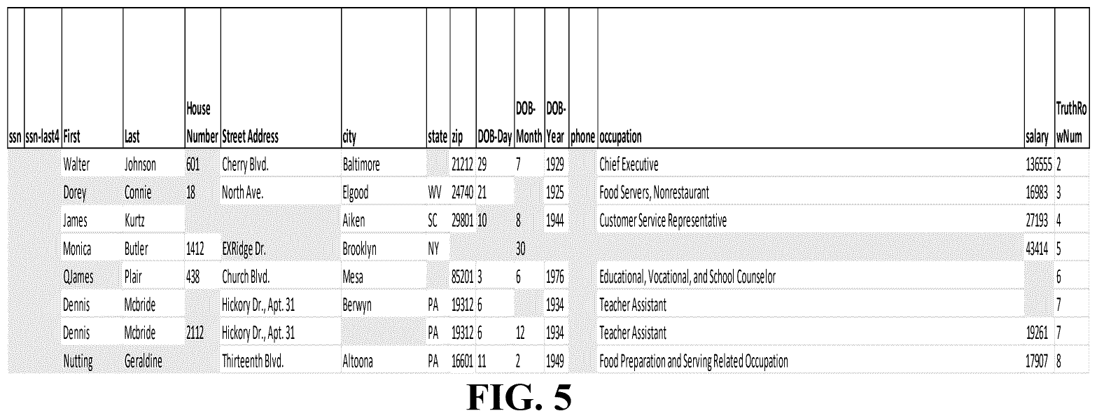

FIG. 6 illustrates a method of string processing according to one or more embodiments.

FIG. 7 illustrates an example visualization of vectorized databases.

### DETAILED DESCRIPTION

The embodiments described in the disclosure, and the configurations shown in the drawings, are only examples of embodiments, and various modifications may be made without departing from the scope and spirit of the disclosure.

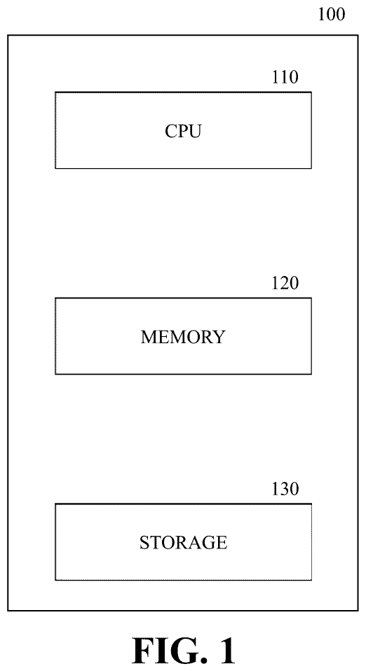

FIG. 1 illustrates a block diagram of an electronic device 100 according to one or more embodiments. The electronic device 100 may include one or more processors or central processing units (CPU) 110, a memory 120, or a storage 130, The CPU 110 may control operation of the electronic device 100, and the memory 220 may store computer program instructions. The CPU 110 may include a digital signal processor (DSP), a graphics processing unit (GPU), a neural processing unit (NPU), a microprocessor, a time controller (TCON), a dedicated processor, a micro controller unit (MCU), a micro processing unit (MPU), a controller, an application processor (AP), a communication processor (CP), an ARM processor, or the like. The CPU 110 may be implemented as a System on Chip (SOC) or a large scale integration (LSI) embedded with a processing algorithm, or as a field programmable gate array (FPGA), for example. The electronic device 100 may also be implemented as one or more application specific integrated circuits (ASIC), a programmable logic device, a discrete gate device, or a transistor logic device.

The memory 120 may include random access memory (RAM) such as static random access memory (SRAM), dynamic random access memory (DRAM), synchronous dynamic random access memory (SDRAM), double data rate synchronous dynamic random access memory (DDR SDRAM), enhanced synchronous dynamic random access memory (ESDRAM), synchlink dynamic random access memory (SLDRAM), or direct rambus random access memory (DR RAM), for example.

The storage 130 may include a data storage device such as a hard disk drive (HDD), a solid-state drive (SSD), a magnetic tape, or an optical disc, for example.

According to one or more embodiments, the CPU 110 of the electronic device 100 may be configured to create vectors for strings and words, based on applying a modified weighted Levenshtein distance. A Levenshtein distance may determine a number of insertion, deletion, matches, or replacement operations to convert a source string into a target string.

To address the limitations of related art methods, one or more embodiments generate numeric vectors for each string in each field of a record. This process may be referred to as word embedding. However, unlike the related art word embedding techniques that are typically trained on large text sources to capture semantic relationships between words, systems, devices and methods according to one or more embodiments of the disclosure may include prioritizing spelling similarity over semantic relationships.

For example, in related art word embedding models, the vector representation of RUN and SWIM would be closer together than RUN and TELEVISION because they share similar meanings. However, when matching records based on spelling similarity rather than meaning, related art word embedding techniques are ineffective. As such, the systems, devices and methods according to one or more embodiments of the disclosure provide a word embedding approach that prioritizes spelling similarity over semantic relationships, ensuring that words with minor spelling variations—such as misspellings or alternative forms—are mapped to similar vector representations

According to one or more embodiments, the CPU 110 of the electronic device 100 may be configured to apply weights to insertions, deletions, and replacements that may be different for each character or character pair. Moreover, according to an embodiment, performing operation to weigh the matches differently. In this manner, more confidence in matches for longer strings or for rarely used characters. However, the disclosure is not limited thereto, and as such, according to an embodiment, weights and matches may be applied in a different manner. Such weights may be applied in order to determine the modified Levenshtein distance.

For example, an exact match on the word TIMOTHY may have more confidence than an exact match on the word YU, because more characters may be matched for TIMOTHY. For example, a weight may also be applied to a position of the operation, and more weight may be applied to the beginning of words. According to one or more embodiments, the CPU 110 of the electronic device 100 may be configured to apply a weight to the position of an operation. For example, the CPU 110 may apply more weight to the beginning of a word.

According to one or more embodiments, the resulting value may be obtained based on Formula 1:

Result=total weighted insertions+total weighted deletions+total weighted replacements+1/total weighted matches. [Formula 1]

According to one or more embodiments, the CPU 110 of the electronic device 100 may be configured to determine a modified Levenshtein distance to a source string and one or more “axis” strings. In an example case in which the source word is TIMOTHY, the modified Levenshtein distance may be applied to:
TIMOTHY versus LLLLLLLLLL,
TIMOTHY vs GGGGGGGGGG,
TIMOTHY versus BBBBBBBBBB, and
TIMOTHY versus NNNNNNNNNN,
providing a numeric value in 4 dimensions and a vector for TIMOTHY.

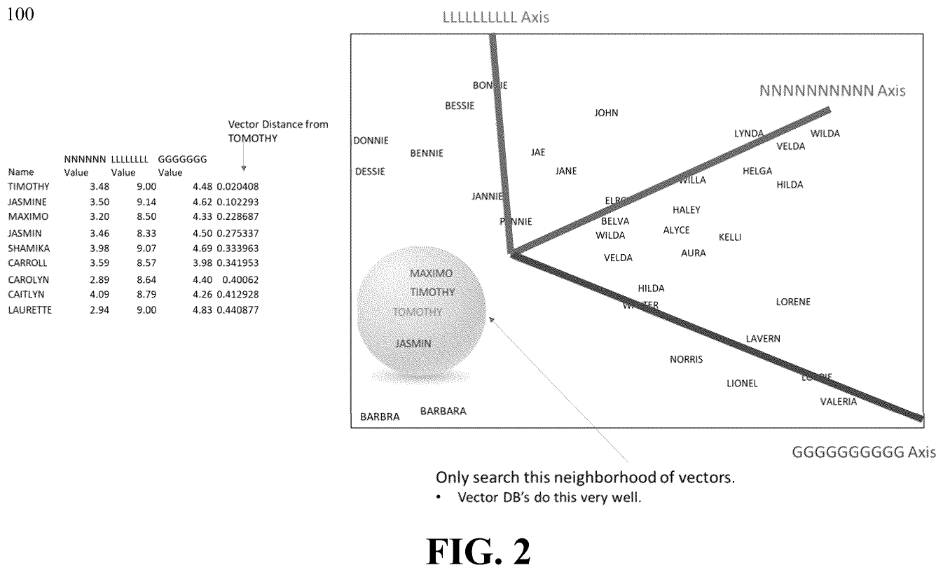

According to an embodiment, additional or fewer dimensions may be included. For example, strings NNNNNNNNNN, LLLLLLLLLL, and GGGGGGGGGG, are depicted as axes of the graph illustrated in FIG. 2. Strings may also be shorter in length, such as NN, LL, GG, and BB. Longer strings may be used to provide more complex character mappings between the source string and the axis strings. The disclosure is also not limited to monotonous strings. For example, strings such as LQLQLQ or other names or words, such as BENJAMIN may be used as axis strings.

According to one or more embodiments, the CPU 110 of the electronic device 100 may be further configured to apply the vector to record linkage. Based on a reference or target database of thousands of names, for example, the modified Levenshtein distance may be applied against each fixed string once to each name in the database to create a vector database for searching. For example, each name in the database may be compared to each fixed string using the modified Levenshtein distance in order to generate the vector database.

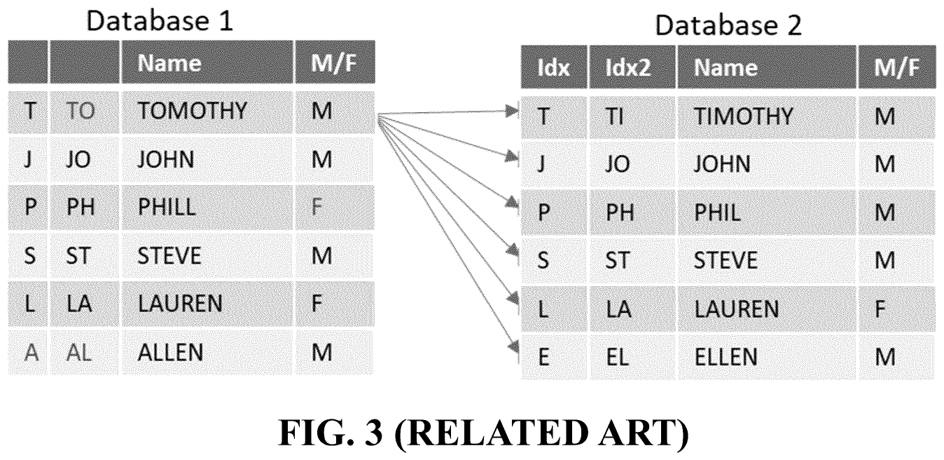

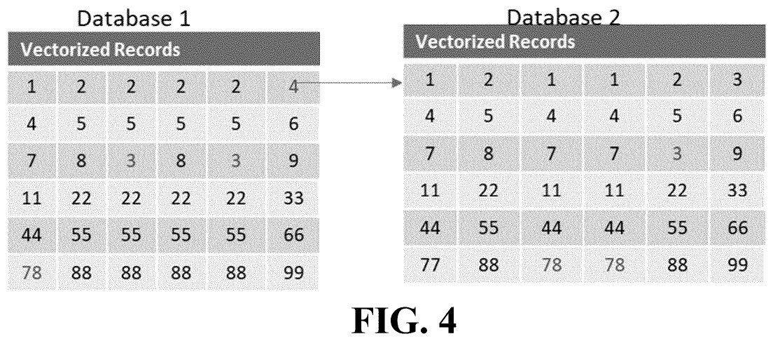

Referring to FIG. 3, the related art string comparison methods require a comparison of every pairwise combination in a reference or target database, as depicted in FIG. 3. On the other hand, as depicted in FIG. 4, the use of the vector approach according to an embodiment of the disclosure may require only one application of Levenshtein calculation to the fixed strings for each record in each DB rather than applying Levenshtein calculation for every pairwise combination of records in the two DBs, thus resulting in significant computational complexity reduction, and greatly reducing the computation cost of such an operation. Examples of vector comparison methods used to perform the vector search illustrated in FIG. 4 include, but is not limited to, K-nearest neighbor, Approximate Nearest Neighbor, or by using a standard proximity search based on a distances, such as Euclidian or Manhattan distances, from a first vector to a second vector. According to one or more embodiments, any known vector comparison methods may be used to perform the vector comparison.

According to one or more embodiments, the method may include generating a word embedding for a given string by computing its distance from a fixed set of reference strings. These reference strings may include predefined letter patterns, such as L's, N's, G's, and B's as illustrated in one of the previous examples or letter patterns such as L's, N's, and G's, as illustrated in FIG. 2. The distance calculation may be based on a modified Levenshtein distance, where insertions, deletions, replacements, and matches are weighted differently depending on the specific character altered.

Additionally, multilateration may be applied to the resulting vector to refine its positioning and further enhance accuracy.

According to one or more embodiments of the disclosure, a key advantage of this approach is that vectorization is performed against a fixed set of reference strings. As such, in the method according to an embodiment, each vector only needs to be computed once. This drastically reduces the number of required comparisons. In the earlier equation, where the total comparisons involved multiplying 350 million by 350 million, this process now shifts from multiplication to addition, transforming the computation time as follows:

$$( 350 M DB 1 records + 350 M DB 2 records ) \times 0.01 sec per comparison \times ( 1 hr 3600 sec ) \times ( 1 day 24 hr ) \times ( 1 year 365 days ) \approx 0.22 years$$

By significantly reducing the number of required comparisons, this method makes large-scale record matching practical and efficient, offering a significant performance improvement (for example, in terms or resources and time) compared to related art methods.

According to one or more embodiments, the CPU 110 of the electronic device 100 may be further configured to apply the modified Levenshtein distance to one or more candidate records to create one or more vectors. The vector database may be searched for the one or more records. The vector databases may optimized for processing.

According to one or more embodiments, a vector database may be searched using a specialized vector search database, such as Milvus, or pgvector. Such specialized vector search databases may be distributed vector databases optimized for efficient search of vectors and vector databases. According to one or more embodiments, a vector accelerator may be used to analyze, search, compare, or otherwise process a vector database. Vector accelerators may include computational units, such as logic units or memory buses, optimized for vector comparison operations. Vector accelerators may include computational units optimized for efficient execution of parallel operations. Vector accelerators may include computational units optimized for efficient execution of computationally simple operations. One of ordinary skill in the art will recognize that the use of specialized vector search databases and/or vector accelerators results in improved accuracy and computational efficiency (e.g., resource and/or time) when compared to the use of generic computer components.

According to one or more embodiments, the vector databases may be a locally stored and/or server based copy of the database. According to an embodiment, the vector databases may be implemented all in memory. According to one or more embodiments, a vector database may be an instance associated with a subscription or software as a service model. According to one or more embodiments the database may be deployed in a serverless manner using cloud based computing.

One of ordinary skill in the art will appreciate that while certain embodiments have been described using vector databases, which may offer certain advantages compared to typical databases, the embodiments of the present disclosure are fully compatible with all typical databases known in the art. Under one or more embodiments, one or more generated vectors may be placed directly into memory, and may be searched according to one or methods of search described in the disclosure.

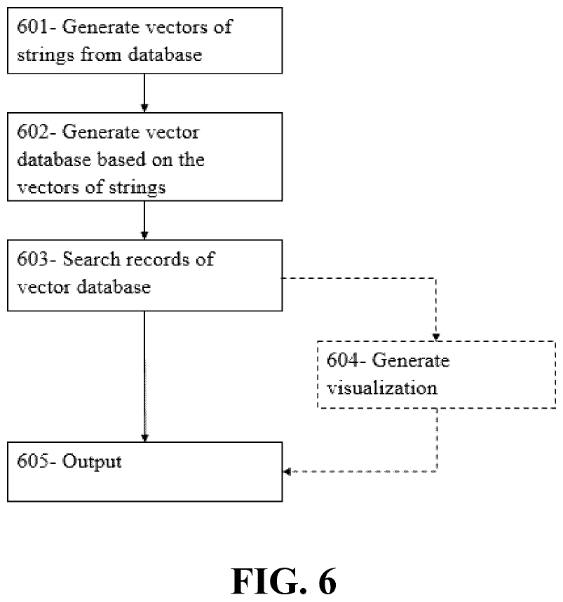

FIG. 6 depicts an example method of string analysis according to one or more embodiments. At operation 601, the method may include generating vectors of strings. For example, the vectors of strings may be generated according to any of the embodiments described herein. At operation 602, the method may include generating a vector database based on the generated vector of strings. For example, the vector database may be generated from the vectors of strings according to any of the embodiments described herein. At operation 603, the method may include searching the records of the vector database. For example, each record in a first of the vectorized datasets may be iteratively searched within a second of the vectorized datasets. In one or more embodiments, a first dataset is searched for duplicates within the first dataset. According to one or more embodiments, each of the vectorized datasets may be passed to a specialized vector search database or vector accelerator, which performs any requested search or processing operations. In one or more embodiments, the results of the search or processing operations are output at operation 605. However, the disclosure is not limited thereto, and as such, according to one or more embodiments, the method may include, at operation 604, generating visualization based on the results of the search or processing operations before the output operation 605, and perform the output operation 605 based on the generated visualization.

According to one or more embodiments, ANN (Approximate Nearest Neighbor) and KNN (k-nearest neighbor) may be used to perform the vector search. One or more embodiments may include indexing of a vector database using methods such as PQ (product quantization), Projections, LSH (Locality Sensitive Hashing) or HNSW (Heirarchical Navigable Small World) approaches. One or more embodiments may include matching vectors according to one or more, or a combination thereof, of similarity metrics including Euclidean, Cosine, Dot Product, and Manhattan methods/distances. One of ordinary skill in the art will recognize that any similar similarity metrics may be used. According to one or more embodiments, the search may include any filtering method known in the art.

As an example, according to one or more embodiments, given a first database DB and a second database DB2, a method of performing a search may include performing, for each record in DB1, a search to find the N nearest neighbors in DB2, and returning the N nearest neighbors. ‘Nearest’ may be defined by a similarity metric such as Euclidean, Cosine, etc. In an example embodiment, where the similarity metric is a dot product, then the database search may calculate the dot product between a record in DB 1 and all the records in DB 2 and then return the records from DB 2 that are the N lowest (closest) values. One of ordinary skill in the art will recognize that such search methods may be altered and/or optimized to best suit the form of database being used.

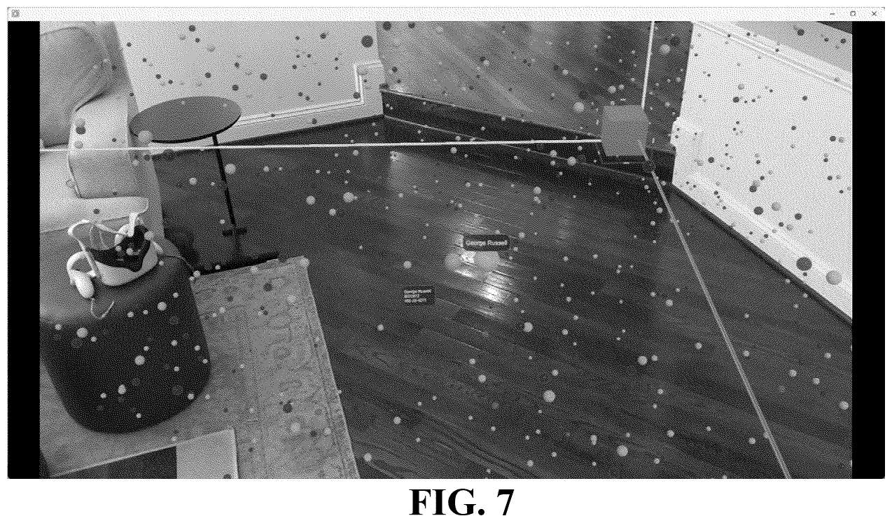

However, the disclosure is not limited thereto, and as such, according to one or more embodiments, the method may include analyzing and/or processing the results of the search. For example, as illustrated in FIG. 7, a multidimensional plot of the search results may be generated, forming a visualization of the search results. In one or more embodiments, a multidimensional plot of the one or more vectorized databases may be generated. In one or more embodiments, any of the generated multidimensional plots may be displayed to a user. In one or more embodiments, the multidimensional plots are displayed in a virtual reality format. Thus, according to one or more embodiments, a user may be able to easily visualize and compare both the total contents of the datasets, as well as the comparison results of the datasets.

By applying dimensionality reduction techniques, vectorized records can be graphically represented in a multi-dimensional space. This visualization allows users to see relationships between records, such as identifying clusters where potential matches exist.

For example, by applying dimensionality reduction techniques according to one or more embodiments, a vector with many elements can be reduced based on a desired amount of dimensions for display. For example, a vector may be reduced to 3 dimensions for display in a 3-D visualization, or 2 dimensions for display in a 2-D visualization. According to one or more embodiments, a dimensionality reduction technique may include algorithms including Multilateration, Principle Component Analysis (PCA), Independent Component Analysis (ICA), and Random Forest. Once a dimensionality reduction has been applied, the reduced vector can be plotted on graphs according to a variety of methods such as Virtual Reality, Augmented Reality, or standard graphing displays.

For example, in a VR-based display, records from Database 1 and Database 2 can be plotted in the same space. For example, in the VR-based display, records from Database 1 may be plotted in blue color and records form Database 2 may be plotted in green color in the same space. This allows users to intuitively observe that matching records are positioned closer together, while non-matching records remain farther apart. Such visualization can be instrumental in identifying issues such as areas of high data density, which may lead to match errors or ambiguous results.

According to an aspect of the disclosure, a single-record search within a large dataset may be efficiently handled. For example, the single-record search within the large dataset may be achieved by first vectorizing the entire dataset once. Then, when a new record needs to be searched, it is also vectorized, and the search is conducted within the pre-vectorized dataset.

For example, given a database DB1 containing 1,000,000 records, and an internet system that captured data from users that respond, according to one or more embodiments of the disclosure, each user response may be vectorized and may be matched against each of the records contained in DB1. According to one or more embodiments of the disclosure, in order to perform the match, records of DB1 are vectorized once and only once. Then, the vectorized response may be added to the contents of DB1. As subsequent responses are received, the contents of DB1 do not need to be vectorized again, and subsequent responses can immediately be matched against the contents of DB1. Thus, resulting in substantial computational efficiency increases.

According to one or more embodiments, the method may include matching two large datasets using a similar approach. First, one dataset may be vectorized once, followed by vectorizing the second dataset once. Then, each record in one dataset may be iteratively searched within the vectorized second dataset, significantly reducing computational overhead compared to related art methods.

For example, given the above DB1 containing 1,000,000 records, and a second DB2 also containing 1,000,000 records, determining matching records according to one or more embodiments would only include the vectorization of each database once and only once. Then, each of the vectorized contents of DB1 may be searched against the contents of DB2 without the need to repeat vectorization or other bespoke processing.

According to one or more embodiments, the method may identifying duplicate records within a single dataset. For example, the identifying the duplicate records within the single dataset may be performed by vectorizing the dataset once and then systematically searching each record within the same dataset to find potential duplicates.

As an example, the vector database may be queried for the top ten closest matches to account for potential misspellings. These top ten records may then be examined more closely. As illustrated in FIG. 2, the vectors for first names using three of the four dimensions may be plotted based on determined similarity. In this example, the vector distances from TOMOTHY indicate TIMOTHY has the shortest distance from among the strings evaluated.

According to one or more embodiments, for full record linkage, the CPU 110 of the electronic device 100 may be configured to apply the modified Levenshtein distance to all string components of the record to be searched, such as a first name, last name, or street name, for example. Components such as age may be considered in numeric form or may be considered based on other similarities or transformations. The CPU 110 of the electronic device 100 may be configured to vectorize an entire record in a similar manner.

According to one or more embodiments, the CPU 110 of the electronic device 100 may be further configured to create a reference vector database of one or more of the vectors of the reference records. For each candidate record, the CPU 110 of the electronic device 100 may be configured to vectorize each element and perform a vector search of the resulting vector in the reference vector database. Some elements such as numeric elements, like an age, for example, may be retained as a number without any conversion.

According to one or more embodiments, the CPU 110 of the electronic device 100 may be configured to apply different weights for insertions, deletions, replacements, or matches.

According to one or more embodiments, the CPU 110 of the electronic device 100 may be configured to apply different weight adjustments for the character operation position in the string.

According to one or more embodiments, the CPU 110 of the electronic device 100 may be configured to apply different numbers of axes.

According to one or more embodiments, the CPU 110 of the electronic device 100 may be configured to apply different strings for the axes (rather than LLLLLL, QQQQQQ, LQLQLQ or BENJAMIN may be used, for example).

According to one or more embodiments, the CPU 110 of the electronic device 100 may be configured to apply different weights on the vector elements as part of a larger vector search (for example, sex may be weighted more significantly than a first name). According to one or more embodiments, the vector search may include any combination of dynamic weighting, filtering, or masking of vector components at query time. One of ordinary skill in the art will recognize that such features represent an improvement to database technologies by enabling greater flexibility of databases and of database searching.

According to one or more embodiments, the CPU 110 of the electronic device 100 may be configured to apply process various components of a full record.

According to one or more embodiments, the CPU 110 of the electronic device 100 may be configured to apply additional methods vector comparison, such as Fellegi Sunter comparisons, for example.

According to one or more embodiments, the CPU 110 of the electronic device 100 may be configured to apply to establish similarities between words or strings for training sets for neural networks or other artificial intelligence or machine learning approaches.

According to one or more embodiments, the CPU 110 of the electronic device 100 may be configured to display a visualization of one or more vectors plotted in multiple dimensions.

One aspect of the disclosure provides novel solutions that eliminates the need for blocking. Existing record linkage solutions may heavily rely on blocking or clustering techniques. Such methods may miss matches due to reliance on record elements being accurate. Another aspect of the disclosure provides improved search speed based on the eliminated need for blocking. Another aspect of the disclosure provides improved accuracy, as full records may be used in the search, and errors in single elements therefore may not exclude candidates from the search of the reference database.

Another aspect of the disclosure provides vectors for strings based on weighted modified Levenshtein calculations being applied to a series of axis strings. Another aspect of the disclosure provides a novel solution for generating a reference database of vectors that inherently includes spelling similarity in the string elements of the vectors and allows weighted searches for vectors that are deemed similar. In this manner, one or more embodiment of the disclosure overcome the drawbacks of the related art record linkage solutions that fail to incorporate vectors.

Another aspect of the disclosure provides a vectorization solutions that may facilitate the advanced visualization display of one or more vectors plotted in multiple dimensions.

In one or more example embodiments, a method for obtaining each of the records from database 1 that is contained in database 2 is as follows:

First, each string may be converted to a vector of, for example, 4 numeric values by applying a modified Levenshtein distance against fixed strings, such as L, N, G, and B, for each field in each record of each database. This vectorization may be performed a single time for every record, and then for all sub-vectors used in full searches.

Once the databases have been vectorized, The records in Database 1 are now searched for in Database 2. Because all the values are now vectors of numbers, this search is extremely fast and can be searched across the entire database without any blocking. In fact, by using databases that are designed for vector searches such as Milvus, this search can be extremely fast (multiple orders of magnitude faster) making it practical to fully and accurately match two databases on the order of hundreds of millions in each database. Such databases can use techniques such as K-nearest neighbor searches to find the best matches. And because there is no blocking, the match can compare against all records and can be extremely accurate.

According to one or more embodiments, distance calculations other than a Levenshtein distance calculation, such as Jaro-winkler, or some combination thereof, may be used.

According to one or more embodiments, the Levenshtein algorithm weights may be adjusted.

According to one or more embodiments, a variable number of fixed strings may be used in the distance comparison. For example, rather than only using 4 fixed strings, any number of strings may be used, such as 1, 2, 10, or 20.

According to one or more embodiments, the content of the fixed strings may be changed.

According to one or more embodiments, transformations or other processing may be applied to vectors in order to enhance accuracy.

According to one or more embodiments, only certain values may be word embedded. For example, name fields may be vectorized, while numeric fields such as age may be left unaltered.

According to one or more embodiments, multiple searches may be performed using dynamically weighted vectors.

According to one or more embodiments, the technical solutions above may be implemented as an electronic device control method.

Those skilled in the art will recognize that a variety of modifications, alterations, and combinations may be made with respect to the above-described embodiments without departing from the scope of the disclosure. Such modifications, alterations, and combinations are to be viewed as being within the scope of the disclosure.

1. An electronic device for record linkage, comprising:
a memory storing one or more instructions; and
a processor configured to execute the one or more instructions to:
generate one or more vectors of one or more strings from a reference database based on a modified Levenshtein distance; and
generate a vector database for spelling similarity based on the one or more vectors,
wherein the modified Levenshtein distance is based on one or more parameters, comprising at least one of: a first number of insertions, a second number of deletions, a third number of replacements, or a fourth number of matches, and
wherein one or more of the one or more parameters comprise a predefined weight.

2. The electronic device according to claim 1, wherein the modified Levenshtein distance is based on a plurality of parameters comprising a plurality of predefined weights, and
wherein one or more of the plurality of predefined weights are different.

3. The electronic device according claim 1, further comprising a storage, wherein the electronic device is further configured to execute the one or more instructions to:
receive a user input of one or more candidate records;
perform one or more vector searches of the candidate records against the vector database; and
write a result of the one or more vector searches to the storage.

4. The electronic device according to claim 3, wherein the electronic device is further configured to execute the one or more instructions to display a visualization plotting the results of the search on a display.

5. The electronic device according to claim 3, wherein the result is based on a similarity search.

6. The electronic device according to claim 5, wherein the similarity search is a Fellegi Sunter comparison.

7. The electronic device according to claim 3, wherein performing one or more vector searches includes using a specialized vector search database.

8. The electronic device according to claim 3, wherein the electronic device further comprises a vector accelerator, and wherein the one or more vector searches is performed using the vector accelerator.

9. The electronic device according to claim 1, wherein the one or more vectors are multidimensional.

10. The electronic device according to claim 1, wherein the modified Levenshtein distance is calculated based on one or more fixed strings.

11. A method for record linkage, comprising:
generating one or more vectors of one or more strings from a reference database based on a modified Levenshtein distance; and
generating a vector database for spelling similarity based on the one or more vectors,
wherein the modified Levenshtein distance is based on one or more parameters, comprising at least one of: a first number of insertions, a second number of deletions, a third number of replacements, or a fourth number of matches, and
wherein one or more of the one or more parameters comprise a predefined weight.

12. A non-transitory computer readable medium, for record linkage, containing computer program code configured to cause a processor to:
generate one or more vectors of one or more strings from a reference database based on a modified Levenshtein distance; and
generate a vector database for spelling similarity based on the one or more vectors,
wherein the modified Levenshtein distance is based on one or more parameters, comprising at least one of: a first number of insertions, a second number of deletions, a third number of replacements, or a fourth number of matches, and
wherein one or more of the one or more parameters comprise a predefined weight.
